(19) United States
(12) Patent Application Publication
(10) Pub. No.: US 2012/0115450 A1
(43) Pub. Date: May 10, 2012

(54) Presence Server Based Name Information

(76) Inventor: Andreas Witzel, Herzogenrath (DE)

(21) Appl. No.: 13/319,085

(22) PCT Filed: May 7, 2009
(86) PCT No.: PCT/EP09/55519

§ 371 Date: Jan. 19, 2012

(51) Int. Cl. H04W 4/16

(52) U.S. Cl. 455/415

(57) ABSTRACT

The present invention relates to a CNAP service in which a name of the calling party is presented to the called party. For retrieving the name, a presence network agent in the mobile switching center accesses the presence server and fetches the name from the presence server before it is introduced into a call setup request message.

### TECHNICAL FIELD

The present invention relates to a method for providing a name information of a calling party to a called party at call setup and to a mobile switching center of a cellular network providing the name information.

### BACKGROUND

3GPP TS 23.141 specifies the presence service, which provides the ability for the home network to manage presence information of a user's device, service or service media even whilst roaming. A user's presence information may be obtained through input from the user, information supplied by network entities or information supplied by elements external to the home network. Consumers of presence information, i.e. watchers, may be internal or external to the home network.

In FIG. 1 the generic reference architectural model for providing presence service is shown. A presence server 10 provided in a home network of a mobile user entity subscribing to a cellular network can retrieve presence information from different sources. Information about the presence of a mobile user entity may b e received from a presence network agent 11 receiving information from various network nodes, such as the MSC server. When the information is received from the MSC server, the PC interface may re-use a CAMEL (Customized Application for Mobile Network Enhanced Logic) mechanism for information retrieval. A PEN interface can be used to forward the information to the presence server 10. Furthermore, a presence information may be provided by the user through a presence user agent 12, the presence user agent being a terminal or network located element that collects and sends user-related presence information to the presence server 10. Here the capabilities of the Ut interface may b e re-used. The Peu interface is used to forward the information to the presence server 10. Furthermore, it is possible that presence information is provided to the presence server from outside the network through the presence external agent 13 using a Px interface. A presentity presence proxy 14, presentity being a combination of the words “presence” and “entity”, is a functional entity that provides the presentity-related functionality, such as determining the presence server associated with a presentity. A watcher presence proxy 15 describes the entity that provides watcher-related functions, such as authentication of watchers, a presence list server 16 being a functional entity that stores grouped lists of watched presentities and enables a watcher application to subscribe to the presence of multiple presentities using a single transaction. Additionally, watcher applications 17 are provided.

Presentity usually refers to a human being and describes the availability and willingness of this human being to communicate via a set of communication services.

Pep and Pen refer to the RFC 3863 for support of transport of presence information under the PIDF format. In addition, Pep provides mechanisms for the presence user agent to obtain information on watcher subscriptions to the presentity's presence information.

Furthermore, a 3GPP calling name presentation (CNAP) service is known, the CNAP service providing the ability to indicate the name information of a calling party to a called party at call setup time for all incoming calls.

A user who has subscribed to the CNAP supplementary service and receives a call also receives the calling name information of the calling party. The calling party takes no action to activate, initiate or in any other manner provide calling name identification presentation. The name of the mobile subscriber may have up to 80 characters of information associated with a specific calling party.

In addition or instead of the name identity the network may give a presentation indicator indicating that the presentation is restricted or the name is unavailable. The calling name identity is provided by the terminating visited mobile switching center (VMSC) to the mobile user entity. The calling name information of the calling party includes either the calling name identity or indication of privacy or unavailability. The name is retrieved from a name database, and the procedures of the name database query are outside the scope of the 3GPP specification.

The precise handling depends on the structure of the name database and a character translation may be required by a terminating mobile switching center, since the name characters stored in a name database are not using the GSM default alphabet (name characters passed to the CNAP subscriber's mobile user entity use the GSM default alphabet). Display of calling name identity to the subscriber is outside the scope of the 3GPP specification. 3GPP provides a non-normative name database query example using the calling party's line identity as specified in ANSI T1.641 (Calling Name Identification Presentation).

As outlined above, the 3GPP specification does not cover the mechanism how the mobile switching center node determines the name. 3GPP just outlines that there is a database where all the names are stored and which can be queried. However, the name database and the query mechanisms may have many national variants. Additionally, those solutions are based on the IN/CAMEL mechanisms.

Summarizing, there exist many national variants making it unattractive for a Telecom vendor to provide the CNAP service as discussed above, since a lot of different variants have to b e supported. The re-use of the IN/CAMEL mechanisms means that the solutions are based on MAP/TCAP protocol stacks which are not supported in mainstream database products. It is impossible for an operator to put the name database on a modern platform. Last but not least putting the name database on an IN/CAMEL based database implies high costs for an operator. Apart from the use of non-mainstream databases, the cost arises from the fact that yet another specialized database is needed which has to be administered and maintained by the operator.

### SUMMARY

Accordingly, a need exists to provide a calling name information allowing to provide a called party with the calling name information without the need of a character translation and needing little administrative work.

This need is met by the features of the independent claims. In the dependent claims preferred embodiments of the invention are described.

According to a first aspect of the invention, a method for providing a name information of a calling party to a called party at call setup for a call name presentation service is provided, wherein it is checked whether the called party has subscribed to the call name presentation service. If this is the case, the name information of the calling party is retrieved from a presence server and included into a call setup request message. This means that a presence server is used as source of information for names as part of the CNAP supplementary service. The name information can be retrieved from the presence server either by an originating mobile switching center or by the terminating mobile switching center. To this end the mobile switching center comprises a presence network agent that retrieves the name information of the calling party from the presence server before it is included into the call setup request message.

According to a preferred embodiment of the invention it is checked whether the called party has subscribed to the call name presentation service by accessing a visiting location register (VLR) of the called party, where the information whether the called party has subscribed to the call name presentation service is present. The subscriber data of the called party is stored in the VLR and has been received from the home location register (HLR) at an initial location update. The subscriber data also include CNAP supplementary service data.

When the presence server is contacted by the presence network agent of the mobile switching center, the former has to be able to differentiate between requests for name information of a calling party and requests for presence information. To this end the step of retrieving the name from the presence server may comprise the step of transmitting a SIP subscriber request to the presence server, SIP being the Session Initiation Protocol which is a signaling protocol used in the IP multimedia subsystem (IMS) architecture. For differentiating a request for a name information from a request for presence information, the SIP subscribe request includes an information that subscription is to a usage of the name information contained in the presence server. Furthermore, the SIP subscribe request may contain the information that it is a non-persistent request, meaning that it is a one-time data request and not a persistent presence data subscription, as it is the case for a request for presence information.

Preferably, the SIP subscribe request is transmitted to a Call Session Control Function (CSCF) unit, from where it is transmitted to the presence server. More specifically, the request is transmitted to the P-CSCF (Proxy CSCF), from where it is transmitted to the S-CSCF (Serving CSCF).

Additionally, it may be checked whether the name information is already available to the mobile switching center before the name information is retrieved from the presence server. There are different options for the mobile switching center (MSC) to have the name information already available. By way of example, the MSC may have fetched the name previously and cached the result in the VLR. There may be a timer allocated to the information in order to clear a cached name from the VLR after a certain time.

Furthermore, the name information may already be available in the MSC, as the MSC may subscribe to the name information in the presence server. In this case the MSC acts as a watcher for the name and is therefore informed by the presence server if the subscriber or the operator changes the name in the presence server.

The step of checking whether the called party has subscribed to the call name presentation server may be carried out by an originating mobile switching center, from where the call from the calling party originates. The originating mobile switching center can then additionally check whether an outgoing signaling system is able to code the name information. If it is detected that the outgoing signaling system is not able to code the name information, the name information is not retrieved by the originating mobile switching center. Thus, in case of missing capabilities of the outgoing signaling system no name information is retrieved by the originating MSC.

In an alternative embodiment the step whether the called party has subscribed to the call name presentation service is carried out by a terminating MSC, from where the call is sent to the called party. This terminating MSC verifies whether the called party and the calling party are present in the same visiting location register before retrieving the name information from the presence server. If this is the case it is checked whether the name information is present in the visiting location register and the name information of the calling party is retrieved from the visiting location register instead of a retrieval from the presence server. In contrast to the originating node, the calling name is normally not available in the VLR, since the calling subscriber may not be served by the terminating MSC. As in many cases the call is a local call, it may be reasonable to still check in the VLR of the terminating MSC whether the subscriber, i.e. a calling party can be found.

Preferably, if the called party and the calling party do not belong to the same operator, the SIP subscribe request is forwarded to the home network of the calling party. If the calling party belongs to the same network or operator as the called party, then the SIP subscribe request messages can be handled by the own network.

According to another aspect of the invention, a mobile switching center providing the name information is provided, the mobile switching center comprising a control unit checking whether the called party has subscribed to the call name presentation service. Additionally, the mobile switching center comprises a presence network agent retrieving or fetching the name information of the calling party from the presence server, the control unit including the name information retrieved from the presence server into a call setup request message. In case the mobile switching center is an originating mobile switching center, the call setup request message containing the name information is sent to the network, and in case the mobile switching center is a terminating mobile switching center, the call setup request message is sent to the mobile user entity.

For retrieving the information whether the called party has subscribed to the call name presentation service, the control unit may access the VLR of the called party. The mobile switching center may work as described above, meaning that it may transmit a SIP subscribe request to the presence server including the information that subscription is to a usage of the name information contained in the presence server. In the case of an originating mobile switching center the latter may check whether the name information can be coded by the outgoing signaling system. If this is not the case, the name information retrieval by the originating mobile switching center may not be initiated.

If the mobile switching center is a terminating mobile switching center, it can verify whether the called party and the calling party are present in the same VLR, the name information being retrieved from the VLR before accessing the presence server for this information.

Reference throughout the specification to “one embodiment” or “an embodiment” means that a particular feature, structure or characteristic described in connection with the embodiment is included in at least one embodiment of the present invention. Thus, the appearances of the phrases “in one embodiment” or “in a preferred embodiment” in various places throughout the specification are not necessarily all referring to the same embodiment. Furthermore, the particular features, structures or characteristics may be combined in any suitable manner in one or more embodiments.

### BRIEF DESCRIPTION OF THE DRAWINGS

The invention as well as a preferred mode of use, further objectives and advantages thereof will best be understood by reference to the following detailed description of illustrative embodiments when read in conjunction with the accompanying drawings, wherein

FIG. 1 is a block diagram of a presence architecture of 3GPP known in the art,

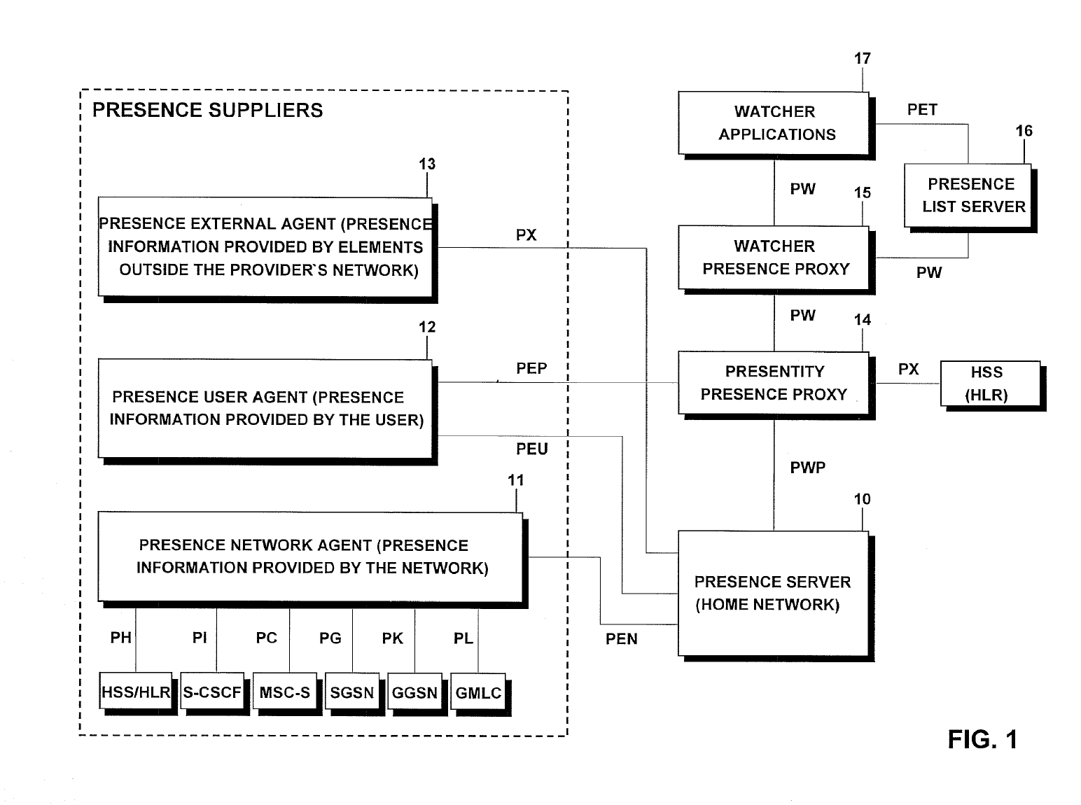

FIG. 2 shows a block diagram of a system where a mobile switching center retrieves name information from a presence server,

FIG. 3 shows a flowchart how an SIP subscribe request is sent from a mobile switching center to the presence server,

FIG. 4 shows a flowchart how a name information is fetched from a presence server in an originating mobile switching center,

FIG. 5 shows a flowchart showing the steps how the name is fetched from a presence server and included in a call setup request message for a call originating from a mobile user entity,

FIG. 6 shows a flowchart comprising the steps how the name information is fetched from the presence server by a terminating MSC, and

FIG. 7 shows a flowchart of another embodiment how a calling name information can be retrieved in a terminating MSC.

### DETAILED DESCRIPTION

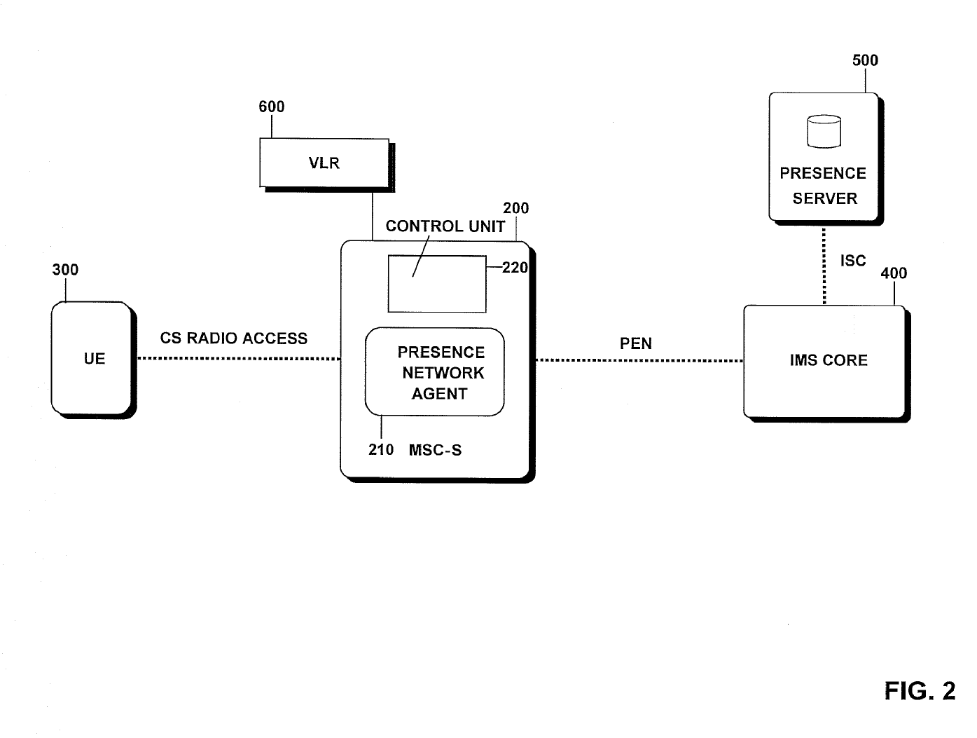

With reference now to the Figs. a system is shown in FIG. 2 allowing to add a name information of a calling party for a call name presentation service. A mobile switching center or a mobile switching center server 200 comprises a presence network agent 210 allowing the MSC to update and fetch presence information from a presence server 500. The MSC server 200 is connected to the presence server 500 via a Pen interface to the IMS core 400, the IMS core being connected to the presence server via a ISC interface.

The MSC server 200 may be the unit handling a call from a mobile user entity 300 in a case where the mobile user entity 300 is the calling party making a call to a called party, the called party being a mobile user entity or a fixed line. In this case the MSC server 200 is an originating mobile switching center from where the call to the called party originates.

In another embodiment the MSC server 200 may be the MSC server where the call from the calling party terminates and from where it is sent to the mobile user entity, the mobile user entity 300 being in this case the called party. In both cases either the originating mobile switching center or the terminating mobile switching center can add a name information of the calling party as described in more detail below. When the mobile user entity is the calling party, the mobile switching center checks whether the called party has subscribed to the call name presentation service. The MSC server 200 is furthermore connected to the visiting location register 600 which may also be used for fetching a name information of the calling party as will be described further below.

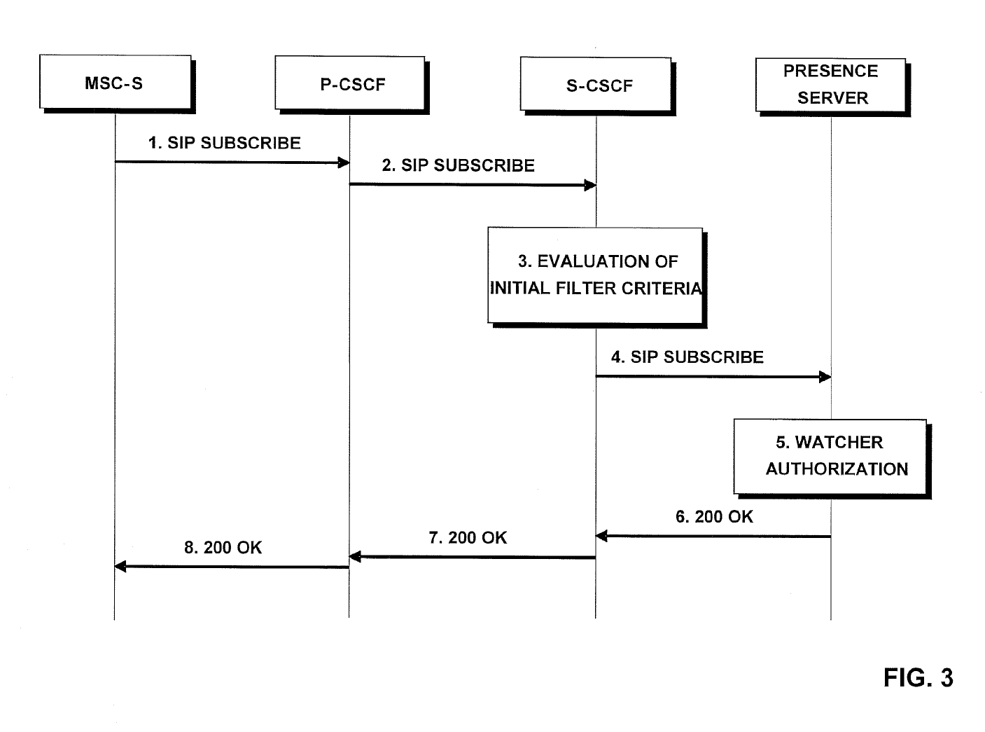

In FIG. 3 it is shown in more detail how the MSC server fetches the name information from the presence server. For this flow it is assumed that the called party has already been registered into the IP multimedia subsystem by the MSC server before. When a call to a called party is detected that has subscribed to the CNAP supplementary service in which the name of the calling party is indicated to the called party, the MSC server sends in step 1 a SIP subscribe message via the P-CSCF to the S-CSCF (step 2). The called party may be a subscriber of the operator operating the MSC server or may be a foreign subscriber. In the latter case the SIP subscribe is forwarded to the home network of the called party where the case is handled as shown in connection with FIG. 2 by the corresponding IMS core. In the S-CSCF unit predetermined filter criteria are provided allowing to filter the SIP subscribe request (step 3), the filter criteria causing the S-CSCF unit to forward the SIP subscribe to the presence server in step 4 allocated to the served subscriber, i.e. the called party. As discussed above, this can be a subscriber of the own network or a foreign subscriber.

In step 5 the presence server carries out a watcher authorization where it is checked whether the requesting party is allowed to have the right to receive information about the calling party. When a calling party A calls a party B as called party, the name of party A should be indicated to party B. The name of party A is fed from the presence server. In the present case this means that party A should be a subscriber of the presence service provided by the presence server and party B should have the right to receive the information from the presence server as a watcher. In steps 6-8 it is acknowledged to the MSC server that the called party B is allowed to receive the name information.

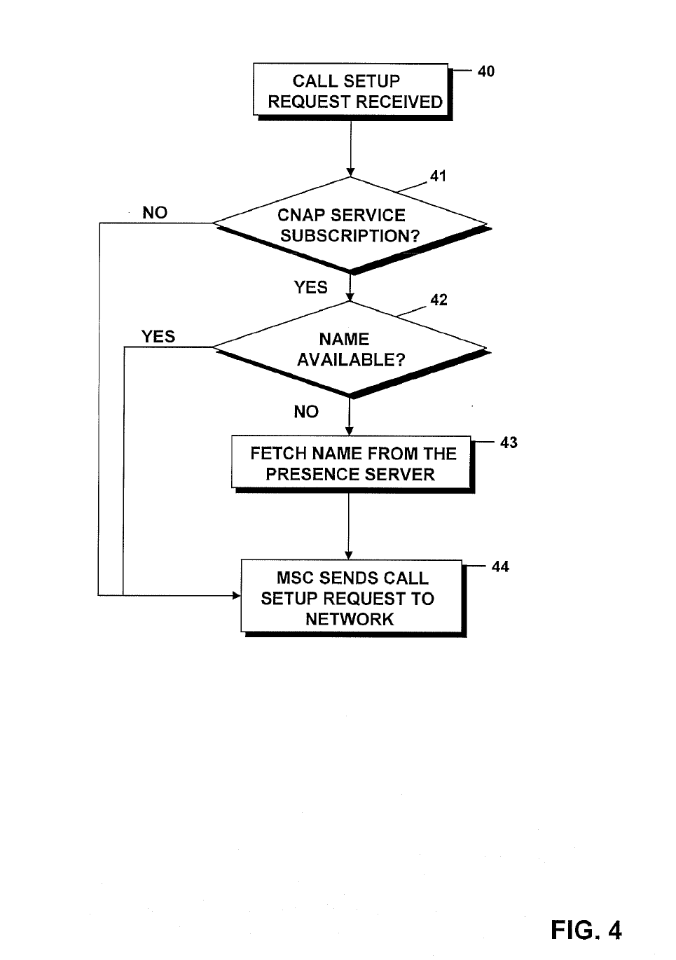

In FIG. 4 the steps carried out at an originating MSC server are shown in more detail. In the CNAP service of the originating MSC server the calling name is determined and included in the outgoing call setup. At step 40 a call setup request of the calling party is received from the called party. The subscriber data for the called party is stored in the VLR where the called party is located, the subscriber data being received from the HLR at the initial location update. This subscriber data also includes CNAP supplementary service data. As a consequence, the originating MSC server contacts the VLR of the called party and determines in step 41 whether the called party has subscribed to the CNAP. If this is the case, it is asked in step 12 whether the name of the calling party is already available. There are different options for the MSC to have the name of the calling party already available: The MSC may have fetched the name previously and cached the result in the VLR. There may be a timer allocated to this name in order to clear a cached name from the VLR after a certain time. Additionally, the MSC may subscribe to the name information in the presence server. In this case the MSC acts as a watcher for the name and is therefore informed by the presence server if the subscriber or the operator changes the name in the presence server. If it is determined in step 42 that the name is not available yet, the MSC server fetches the name from the presence server as described in connection with FIG. 3, the name information being transmitted back from the presence server to the MSC after steps 6-8, as will be described further below. After the name has been determined, the name information is added to the outgoing call setup request sent by the originating MSC in step 44. If it is determined in step 41 that the called party is not a subscriber to the CNAP service, the setup request message is sent without the name information. If it is determined in step 42 that the name is already available, the name information is included in the call setup request.

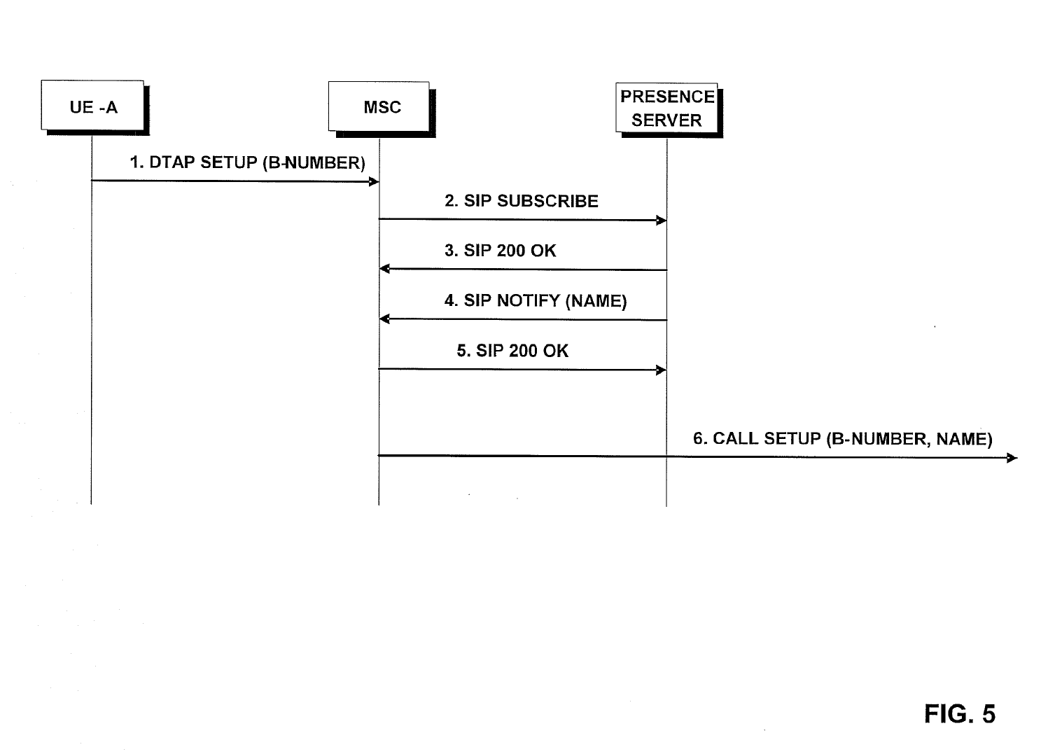

The inclusion of the name into the call setup request is shown in further detail in FIG. 5. When mobile user entity A as calling party dials a number of the called party B, a DTAP setup message is sent in step 1 to the MSC server including the number of the called party. In steps 2 and 3 the subscribe message is sent to the presence server, an OK message being sent back in step 3. Steps 2 and 3 of FIG. 5 were discussed in further detail in connection with FIG. 3. In step 4 a SIP notify message including the name information is sent from the presence server to the MSC, the MSC acknowledging receipt thereof in step 5. In step 6 the MSC then includes the name information if available into the call setup request message sent to the network from where it is further transmitted to the called party.

The presence server receiving the SIP subscribe message should be able to differentiate between messages requesting a presence information from a subscriber and messages where only the name information is requested. Accordingly, the SIP subscribe message includes the information that the subscription is to the name presence information data indicating to the presence server that subscription is to a usage of the name information and not the presence information contained in the presence server. Additionally, it may contain a SIP expiry header set to 0, which indicates to the presence server that this subscribe is a “one time” data request and not a persistent presence data subscription. For an originating MSC it may happen that the coding of the name in the outgoing call request depending on the outgoing signaling system may not be possible in certain older signaling systems. As a consequence, the MSC may determine the outgoing signaling system in beforehand and may skip the name determination in case of missing capabilities of the outgoing signaling system. With reference to FIG. 4 this can mean that before it is requested whether a subscription to the CNAP service is present. In step 41 a step is carried out asking whether the name can be coded in the outgoing signaling system.

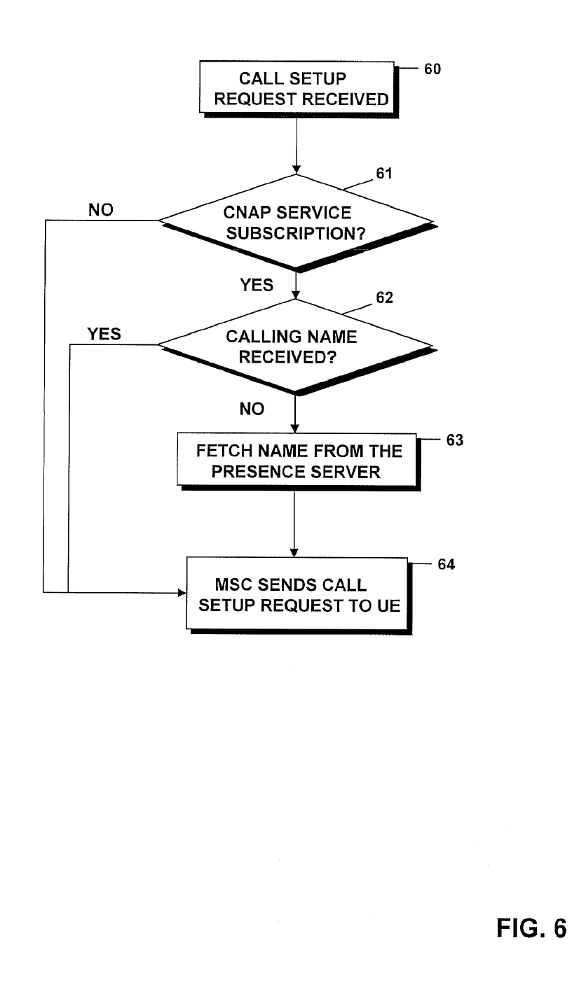

The name information may not only be added by the originating MSC, but also by the terminating MSC. In connection with FIG. 6 the steps carried out by a terminating MSC are shown in further detail. If a call setup request message is received in step 60 at a terminating MSC, it is again asked in step 61 whether the called party has subscribed to the CNAP service. In the affirmative it is checked in step 62 whether the calling name has already been received together with the call setup request message, as it may have already been incorporated by the originating MSC as discussed above. The subscriber data for the called party is again stored in the VLR and has been received from the HLR at the initial location update, the subscriber data including CNAP supplementary service data. If it is determined that the calling name is already contained in the received request, the MSC can directly continue the call setup as normal sending the call setup to the mobile user entity in step 64. If it is determined in step 62 that the calling name is not contained in the call setup request message, the name can be fetched in step 63 from the presence server. The procedure of step 63 is the same as for the originating MSC using SIP subscribe and SIP notify. In the receiving network node the calling name is normally not available in the VLR in contrast to the originating node, as the calling subscriber may not be served by the terminating MSC. However, in one embodiment it can be checked whether the calling name is available in the VLR of the called party, as local calls are a dominant call case.

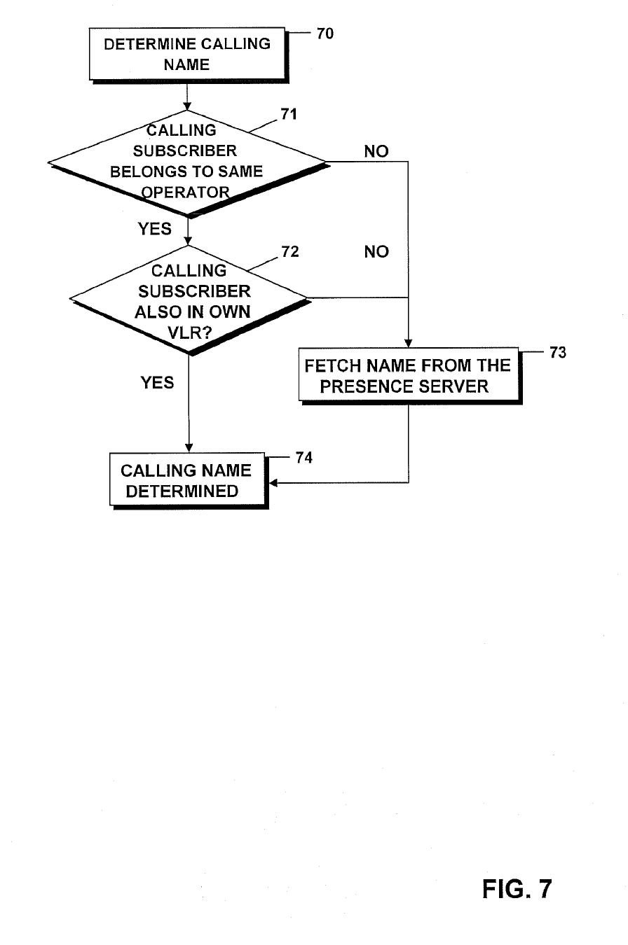

This embodiment is described in further detail in connection with FIG. 7. For the determination of the calling name in step 70 it can be asked in step 71 whether the calling subscriber belongs to the same operator. If this is not the case, the calling name may be fetched from the presence server in step 73. If, however, the calling subscriber belongs to the same operator as the called subscriber, it can be asked whether the calling subscriber is present in the same VLR as the called subscriber. In this situation the query from the presence server may be omitted and the calling name is determined by accessing the VLR instead of fetching the name from the presence server. If the name of the calling subscriber is not present in the VLR, the name is fetched from the presence server in step 73.

If the calling subscriber belongs to the same network or operator as the called subscriber, then the SIP messages are handled by the own network. Otherwise, the SIP subscribe is forwarded to the home network of the called subscriber and handled there. The signaling sequence as such is however identical.

In the case of IMS interworking the media gateway control function (MGCF) converts the CNAP name information of the CS signaling into the corresponding CNAM (Calling Name Delivery Information) IMS service name information of the IMS signaling.

Summarizing, the present invention allows to deploy the CNAP feature much more easily, since an already existing presence server can be used, and there is no need for the operator to administer the name database, as this is done by self-administration by the subscribers. Additionally, in the present case mainstream databases and presence server products are used. This allows one global solution for different markets.

1-15. (canceled)

16. A method for providing a name information of a calling party to a called party at call setup for a call name presentation service, the method comprising:
checking whether the called party has subscribed to the call name presentation service,
retrieving the name information of the calling party from a presence server, and
including the name information retrieved from the presence server into a call setup request message.

17. The method according to claim 16, wherein checking whether the called party has subscribed to the call name presentation service comprises accessing a visiting location register of the called party and determining whether the called party has subscribed to the call name presentation service.

18. The method according to claim 16, wherein retrieving the name information of the calling party from the presence server comprises transmitting a SIP subscribe request to the presence server.

19. The method according to claim 18, wherein the SIP subscribe request includes an information that subscription is to a usage of the name information contained in the presence server.

20. The method according to claim 18, wherein the SIP subscribe request is a non-persistent request.

21. The method according to claim 18, wherein the SIP subscribe request is transmitted to a call session control function unit, from where it is transmitted to the presence server.

22. The method according to claim 16, further comprising checking whether the name information is already available to a mobile switching center before the name information is retrieved by the mobile switching center from the presence server.

23. The method according to claim 16, wherein checking whether the called party has subscribed to the call name presentation service is carried out by an originating mobile switching center from where the call from the calling party originates, the originating mobile switching center additionally checking whether an outgoing signalling system is able to code the name information, wherein the name information is not retrieved by the originating mobile switching center when it is determined that the outgoing signalling system is not able to code the name information.

24. The method according to claim 16, wherein checking whether the called party has subscribed to the call name presentation service is carried out by a terminating mobile switching center from where the call is sent to the called party, the terminating mobile switching center carrying out the following steps before retrieving the name information from the presence server:
verifying whether the called party and the calling party are present in the same visiting location register,
checking whether the name information is present in the visiting location register, and
retrieving the name information of the calling party from the visiting location register.

25. The method according to claims 18, further comprising forwarding the SIP subscribe request to a home network of the calling party when the called party and calling party do not belong to the same operator.

26. A mobile switching center of a cellular network providing a name information of a calling party to a called party at call setup for a call name presentation service, the mobile switching center comprising:
a control unit configured to check whether the called party has subscribed to the call name presentation service, and
a presence network agent configured to retrieve the name information of the calling party from a presence server, wherein the control unit includes the name information retrieved from the presence server into a call setup request message.

27. The mobile switching center according to claim 26, wherein the control unit accesses a visiting location register of the called party from where an information whether the called party has subscribed to the call name presentation service is retrieved.

28. The mobile switching center according to claim 26, wherein the presence network agent transmits a SIP subscribe request to the presence server, the SIP subscribe request including an information that subscription is to a usage of the name information contained in the presence server.
